(19) United States
(12) Patent Application Publication
(10) Pub. No.: US 2012/0290428 A1
(43) Pub. Date: Nov. 15, 2012

(54) CENTRALIZED COMMERCE AND THE IMPLEMENTATION OF ENTERPRISE SOFTWARE APPLICATIONS

(75) Inventors: Moshe Ben-Bassat, Zur Moshe (IL); Israel Beniaminy, Ramat Gan (IL); Gil Bouhnick, Ramat Gan (IL); Tal Geffen, Ramat Hasharon (IL); Mike Karlskind, Stow, MA (US)

(73) Assignee: CLICKSOFTWARE TECHNOLOGIES LTD, Petach Tikva, (IL)

(21) Appl. No.: 13/285,003

(22) Filed: Oct. 31, 2011

Related U.S. Application Data
(60) Provisional application No. 61/483,759, filed on May 9, 2011.

(51) Int. Cl. G06Q 30/06

(52) U.S. Cl. 705/26.5

(57) ABSTRACT

A method for selling business applications requiring non-trivial integration, customization and configuration via an application store configured as a centralized virtual shop. The method includes selecting a starter kit by a member of the user organization that best matches needs, enabling a plurality of application buyers and application configurers to work with the starter kit to discover any gaps that may remain and plugging-in additional apps and widgets and removing unneeded components to assemble the full solution configuring and tuning setting parameters and testing.

### RELATED APPLICATION

This application claims priority under 35 U.S.C. §119(e) to U.S. Provisional Application No. 61/483,759, filed May 9, 2011 which is hereby incorporated by reference in its entirety.

### FIELD OF THE INVENTION

The present invention relates generally to selling business applications, and more particularly, to selling business applications requiring non-trivial integration, customization and configuration via a centralized virtual shop.

### BACKGROUND OF THE INVENTION

The following are examples of the prior art:

1. Selling out-of-the-box consumer software applications via any number of unrelated physical shops or virtual shops

Example: Best Buy, Amazon, vendor shops and sites

2. Selling out-of-the-box consumer applications via centralized virtual shops

Examples: Apple iTunes (App Store), Google Android Marketplace

3. Selling out-of-the-box business applications via any number of unrelated physical shops or virtual shops

Examples: Vendor sites, Amazon

4. Selling out-of-the-box business applications via centralized virtual shops

Examples: Google Apps, Salesforce

5. Selling business applications requiring non-trivial integration, customization and configuration via vendors or resellers (not via any centralized shop), with the help of consultants

Examples: Vendors such as SAP, Oracle; Consultants such as IBM, Accenture.

Because Apple's App Store is for consumers, companies are unable to distribute in-house apps on the App Store. Under Apple's iOS Developer Enterprise Program companies can publish in-house apps using an Enterprise App Store. Note that the enterprise app store described is internal to that specific enterprise and can only sell in-house apps. i.e., apps developed by that business for that business.

The challenge of providing business applications

Business applications are part of the overall enterprise IT environment: A mobile business application runs on a mobile device, but it is rarely self-sufficient to run stand-alone. In the vast majority of the cases it is part of the overall enterprise IT environment and shares data, business objects, and workflows with back-office systems, as well as other mobile applications and mobile users in different business roles. The same applies to a business application that is accessed via other devices, not necessarily mobile, such as a desktop computer using a “thin client” (typically in a web browser) or a “rich client” (typically as a software program locally installed on the desktop).

Business users expect coverage of broad integrated workflows; not narrow isolated functions: Furthermore, business users are typically quite demanding, and, in order for an application to be accepted by its user community, it should offer rich workflows that cover most, if not all, of the business functions for a given user's role in an integrated smooth manner. As an example, a mobile solution for a field service cable technician should cover the ability to receive a work order from a back-office system, open it and expect to find all information items required to deliver the job, get travel guidance to the service location, scan devices in a consumer's residence, download technical documentation to support the repair job, complete repair reports, up-sell additional products and services, and report timesheets. This is in contrast to today's consumer level apps that typically stand alone and are used in isolation with minimal expectations for interaction between them. In these consumer apps, what is done in one app remains inside that app. Another example: when an employee uses the Human Resources (HR) app to ask for vacation, the employee's manager should see on his mobile device the impact on work plans and pending tasks before deciding, where the data is from the planning app; and if approved, the worker's tasks should be assigned to other people (scheduling and dispatch app).

Servers as part of the application: In consumer-oriented apps, the server-side does not always exist (e.g. a game or calculation application may be self-contained); If it exists, it is the same for all users. E.g. Facebook app talks to Facebook servers, or app to find a parking spot talks to a central server that monitors parking spot availability. It is never part of the sales, configuration or deployment process. By contrast, the server side always exists for business applications, and is different for each business, even if it's on the cloud, and even if fully multi-tenant: it is part of the enterprise Information Technology (IT) system. Almost every business app produces some output that needs to be recorded on back-office servers, and very frequently they receive input from back-office servers, e.g. a work order downloaded to the mobile device of a technician. Each enterprise gets different behavior and different integration, on the server side as well as on the device side. Therefore the server part of the application is an extremely important part of the sales, configuration or deployment process.

Deployment: In consumer-oriented apps, deployment is typically done by the end-user, and is a matter of one click or touch to download the app or access it directly if no download is required, as in web-based apps. By contrast, for business applications, the deployment is more complex, and is typically not done by the end-user but by IT professionals on behalf of the end-user.

Sales process and pricing: In consumer-oriented apps, pricing and payment terms are rigid and set by the app store and/or the app vendor. Typically one click or touch suffices for the buyer to approve these terms and to authorize payment, so there is no room for negotiation. By contrast, for business applications, the sales process almost always involves evaluation, bidding, negotiations, bidding etc. It also often involves buying from more than one party. For example, to get the full solution the customer may need to buy software from one or more vendors, buy consulting services, buy testing services and so on. Prices and pricing terms may also be creative and change from one deal to the next e.g. permanent license, payment per user per month, payment per number of transactions, etc.

Adaptation: Unlike consumer-oriented apps, which people accept “as is” and do not expect to be able to modify in order to adjust to their unique personal needs/desires, business software is expected to enable adaptations. Often, company executives will guide their search committee to look for a product vendor that requires no customization. However, even in the vast majority of such cases there will always be just “this little twist” in business practices that the company cannot do without, and which necessitates some adaptation/customization/add-on. No business software vendor can claim that 100% of his clients implement its software with no customization. Additionally, very few companies can claim that they implemented an enterprise software solution with 0% customization. The desire is there, but reality and intra-company forces are such that the very important goal for 0% customization can rarely be fully achieved and all one can do is to minimize the need for customization, and to make the remaining customization as quick and simple as possible. Therefore an enterprise software product is also measured by its ability to accommodate adaptations and extensions or add-ons.

Testing and Quality Assurance (QA): Even if one succeeds in building an enterprise solution with no customization, and certainly if one does not, still there will be a need for some configuration and parameter setting, as well as data integration. Accordingly, prior to putting a business solution into production, it requires adequate testing and quality assurance. This is even more important for mobile applications, where reliability is more critical while testing needs to consider many more situations, such as different mobile devices, different levels of connectivity including no connectivity, and more. In large implementations scalability testing is also crucial and are preferably carefully done.

The above challenges and more led to the present invention for development of a unique concept of a “place” where one can buy not only software business products and modules, but also use auxiliary tools and services to ensure rapid development and deployment of mobile business solutions.

Thus, it would be advantageous to provide a solution for selling business applications requiring non-trivial integration, customization and configuration via a centralized virtual shop for business software. I.e., prior art in the field of business software has no parallel to the ease of use of finding, selecting, buying and installing software seen in mobile consumer application stores such as Apple's App Store and Google's Android Marketplace.

### SUMMARY OF THE INVENTION

Accordingly, it is a principal object of the present invention to provide for selling business applications, including business applications that require non-trivial integration, customization and configuration via a centralized virtual shop for business software.

It is an added principal object of the present invention to enable ease of use for finding, selecting, building, assembling, buying and installing business software, similar to the ease seen in mobile consumer application stores, such as Apple's App Store and Google's Android Marketplace, while addressing the needs of configuring, customizing, assembling, integrating, testing, and rolling out such business software.

It is one other principal object of the present invention to enable mobile business applications, that is, applications that access enterprise IT functionality and other functionality via mobile devices. This includes “office mobility”—that is, enabling mobile access to the same business functionality that people already access within their offices, such as vacation approvals; and “field mobility”—that is, enabling mobile access to business functionality which is related to field activities outside the office, such as inspection and field service. It also includes functionality that applies to both office and field scenarios.

A method for is described for selling business applications requiring non-trivial integration, customization and configuration via an application store configured as a centralized virtual shop. The method includes selecting a starter kit by a member of a user organization that attempts to match needs, enabling a plurality of application buyers and application configurers to work with the starter kit to discover any gaps that may remain and plugging-in additional apps and widgets and removing unneeded components to assemble the full solution configuring and tuning setting parameters and testing.

Gaps are defined as the difference between each iterative level of adaptation from starter kit to finished product (this is the “WISIK,” defined below). Business software is expected to enable adaptations. Therefore an enterprise software product is also measured by its ability to accommodate adaptations and extensions or add-ons.

Prior to putting a business solution into production, it requires adequate testing and quality assurance. This is even more important for mobile applications, where reliability is more critical while testing needs to consider many more situations, such as different mobile devices, different levels of connectivity including no connectivity, and more. In large implementations scalability testing is also crucial and are preferably carefully done.

Applications described by the present application deal with access and execution of enterprise IT functionality and other functionality via mobile devices, however the present invention is not limited to mobile applications, and the invention relates to any kind of business application.

Roles in the selection, buying, configuration and deployment process: One of the implications of the above differences between consumer-level applications and business applications, as described in the background, is that there are different roles for consumer software vs. business software:

For Consumer software, there are three roles in the vast majority of the cases:

1. Software vendor

2. Consumer application store

3. Consumer

For Business software, more roles are typically involved:

1. Application software vendor

2. Software vendor for application extensions (described in more detail as “plug-ins” and “widgets” in the invention description below)

3. Application platform vendor (software vendors develop their software to run on top of the business application platform software, so that they can save work by using the platform services and so that the software vendor's application can interact with applications that other software vendors developed for the same platform)

4. Infrastructure platform vendor (sometimes the application platform and the infrastructure platform come from same company; however, as explained below, there are advantages for an application provider to make its software run on several infrastructure platforms thus making its applications appeal to wider audience. In any case the present invention applies to both cases.)

5. Enterprise application store, where applications and infrastructure products, as well as auxiliary widgets can be purchased

6. Business decision makers at the buyer organization:
a. Operations manager (in charge of the groups which will be the application's end-users)
b. IT manager (in charge of the groups which will be responsible for configuring, customizing, integrating, deploying and managing the application, often assisted by external consultants)
c. Financial manager

7. Business end-users

8. Business, system integration (SI) and Information Technology (IT) consultants

9. Service providers, delivering such services as custom software development, testing and quality assurance, information security assessment, DRP (Disaster Recovery Planning) and more

10. Business IT staff: support for configuring, customizing, integrating, deploying and managing the application

As stated above, the prior art does not include any technology or well-defined process to support the interaction of all these roles.

The present invention provides a centralized application store for interaction, business dealings, application configuration, and application deployment for any kind of business applications, including business applications requiring non-trivial integration, customization and configuration.

There are two main activities in using the store to create an application customized for use by a specific business organization. First, select the Starter Kit that best matches one's needs, and let the end-users work with it to discover any gaps that may remain (the Starter Kit concept is explained below). Second, by plugging-in additional apps and widgets the full solution is assembled, possibly contracting third-party consultants and services to help in this and other steps. If one needs modules which do not exist within the enterprise app store, one can develop them and make them available to this and future projects, maybe even selling them to others via the store. Once the application is created, the next steps include configuring and tuning setting parameters, testing, and finally installing it into the mobile devices of its user population.

The role of modular building of software: In today's world it is very rare that a software product or a customized solution is built totally from scratch with no use of modules some of which are major corner stones of the final “finished result.” No one would think today of building his own Data Base Management System (DBMS) functionality, or not using User Interface gadgets extensively. In today's world, many other types of modules are available for application creation. Specifically for mobile business applications, this principle also applies to the basic connectivity middleware functionality, or device management.

A key part of the invention is the extension of this modular building across many levels of modules, from composing an application out of a number of high-functionality modules which are applications in their own right, via adding an already-packaged business workflow into an existing application, and down to lower levels such as adding a “widget” (packaged functionality, typically manifested as an area in the user interface) into a workflow to an existing application. To support this extension, the Application Studio: “A platform for rapid development and deployment of mobile business solutions” is provided. The Application Studio, that is an integral part of the Application Store, is a tool where a developer can find not only end user solutions and many reusable App modules (described as “plug-ins” and “widgets” in text below), but also a workbench with all the tools required to shape the apps in any way desired, integrate and package his work into “finished good” for end user use, and even test it before deploying to the intended end users.

The intended person visiting the application store is an IT professional seeking to build a business solution for an end user. The application store offers the end user solutions in several areas, e.g. Field service and Asset Management, with quite comprehensive coverage, as well as numerous additional reusable Apps that can be connected and integrated with end user solutions. Beyond support for this intended person, the store provides support for additional roles involved in the process, as mentioned in the above list of roles. Examples include training and consulting services as well as outsourcing services.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic diagram illustrating the WISIK (as described below) high-level principle, constructed in accordance with the principles of the present invention;

FIG. 2 is a schematic diagram of the application store components and interactions, constructed in accordance with the principles of the present invention;

FIG. 3 is a flow chart illustration of the application store process, constructed in accordance with the principles of the present invention;

FIG. 4 is another view of the iterative process detailed in FIG. 3, combining it with the concept of WISIK and “WISIK point”, by showing a sequence of iterations leading to customer's decision that the application now meets all the needs, constructed in accordance with the principles of the present invention;

FIG. 5 is flow chart summary of the iterative process in FIG. 4, constructed in accordance with the principles of the present invention; and

FIG. 6 is system diagram illustrating two preferred embodiments, public and private, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

Infrastructure Platform vs. Business Application Platform

An optional part of the invention is the separation between the infrastructure platform and the business application platform. In prior art, these are often taken as a monolithic single platform, on top of which software developers develop specific applications. This platform provides services which accelerate application development and enable application management, scalability, robustness and integration. Examples for robustness services include fail-over to backup server when a server crashes, and integration.

For mobile applications, services that we regard as part of the infrastructure platform include device management, connection management, data management, and data synchronization; whereas services we regard as part of the business platform include business entity (object) definition, workflows, business rules, integration, alert management, business monitoring and analysis, and user interface functionality. A similar division can be made for other types of applications.

WISIK and Starter Kit Concepts

The need for agility rules out the traditional software development process, where one starts with business analysis, and requirements analysis, and approval of the specification, design a technology solution to support the planned business processes, hand the design to be coded in some programming language, and then deliver the end product for testing. Not only is this process far too slow and expensive, it very often produces solutions which, no matter how perfectly it matches the documented requirements produced by the painstaking analysis, it still fails to gain user acceptance in the real world. Why does this happen? Veterans of such projects know the answer: one cannot expect a business user to read hundreds of pages of a Word document and imagine from it the way the solution will work for all the wide variety of real life situations.

When deploying a software product, as opposed to developing a largely customized solution, the very existence of the product offers new possibilities which are the basis for the present invention described herein.

The invention described here follows what we call the WISIK paradigm, where WISIK stands for “When I See (it) I'll Know (it).” In other words: the sooner a user sees a solution and tries it out, the sooner he can point out what he likes and what he wants changed. WISIK's premises are:

1. It is easier to modify a full working solution then to build it from technology building-blocks or from scratch.

2. Watching a working product on a variety of business scenarios is far faster and better for grasping what it will do than poring over analysis and requirement documents: the product is the best documentation of itself.

3. If one only does “no-coding” configuration changes, one shaves several weeks of testing and can quickly cycle through user comments and requests.

4. Agility—enabling short iteration cycles which have a decision or exit point at each iteration, so that progress is continually made available for user review, and that new requirements can be handled quickly.

Having a Starter Kit is crucial for the WISIK methodology. A Starter Kit serves as a “self-contained,” ready-to-be-used software to which one can attach and/or remove business functionality. The term “ready to be used” means that that an end user can run it right away, and that means: (a) all functionality setting parameters are populated with default values representing ‘people like you would have set settings like that,’ (b) sample data is included, and (c) all infrastructure is included with their default settings.

Therefore, a “Starter Kit” is a pre-configured, working solution, which is packaged to fit “best practices” for the type of application and for the characteristics of the organization requiring the application. Characteristics may include the organization's vertical industry, territory, size etc. Thus, users start with a working solution and configure, customize, or extend it in a way that all along a working solution is maintained, while having the ability, from the first day, to examine the application's behavior with the intended business users. At a certain point the business users reach the WISIK Point: “When I See (it) I'll Know (it),” which is the point when the organization is ready to package and test the application.

The scope of Starter Kits may vary. As a minimum, it contains all “essential” technology elements (in the case of a mobile application starter kit, this could include mobile connectivity, integration with back-office systems, data bases, and more) together with “sockets”, i.e. connectors to which additional apps can be attached, thus enriching its functionality. In most cases a Starter Kit also contain business functionality to cover the “basics” in a given industry domain, i.e. the common denominator of most RFP's (Requests For Proposals) for this domain. A wide spectrum of Starter Kits may be offered. The following two examples illustrate the two ends of the spectrum, from ‘ready to deploy’ to basic, for the domain of mobile business applications:

### 1. Field Service Starter Kit:

This is for end users in industries with field service and asset management workforces. It covers most functionality required by these mobile workers ‘out of the box,’ and deployment primarily involves configuration of existing functions. As described above, all setting parameters have default values and sample data is included so that an end user can run it right away and watch its behavior.

### 2. Minimal Starter Kit:

Aimed at developers of mobile business applications in areas radically dissimilar from those areas covered by existing starter kits, who prefer to start from only the “bare trunk and root.” That is, all and only that is absolutely necessary for a mobile business solution to be “minimally functional” on both the server side and the device, i.e. user side. Of course the ‘necessary’ aspect of the Minimal Starter Kit is a subjective concept. In the worst case, if the Starter Kit includes any modules above the bare minimum for a developer's needs, these can be removed.

Each Starter Kit includes a set of configurable options governing its behavior, integration, user interface and more. It also includes a set of “sockets” for addition of plug-ins. Starter Kits may be enhanced by adding “plug-ins.” Plug-ins are implementations of business functionality which are encapsulated to include all the parts required for that functionality, potentially including database definitions, server-based functionality, client-side functionality (where the client may be any type of device, including desktop computers, laptops, netbooks, tablets, smartphones etc., using either a “zero-footprint” application where nothing is installed on the device or a native application that involves device installation), server-side functionality, integration etc. Examples of plug-ins include time-sheet management, sales, inspection reports, job dispatch, expense accounts and more. Plug-ins are designed to fit into Starter Kit sockets, so that the result is one cohesive application. For example, when adding timesheet management into a field service Starter Kit, the field service functionality can use the socket to automatically load information into the time sheet, such as start and end times for each repair job performed. This is a major time saver, not to mention error prevention, since the field service engineers will not have to manually enter start and end times as they would have to do if the timesheet functionality was a separate application.

Applications, therefore, are constructed by selecting the appropriate starter kit and adding or removing plug-ins. A further way to customize the application's behavior is to use widgets. Widgets are relatively small and self-contained pieces of functionality which may be inserted into applications to add a technological feature, enhance the user interface, support specific types of integration, etc. Note that the dividing line between plug-ins and widgets may be fuzzy, though widgets are generally not intended to stand for all steps of a business workflow: they are intended to supplement and enhance certain steps in the workflow by adding specific functionality that is typically usable in many business contexts, while plug-ins relate to specific business contexts and workflows. Examples of widgets, from the domain of mobile applications, include signature capture, barcode scanning, parts availability query, access to the corporate portal and more.

Like Starter Kits, plug-ins and widgets also include sets of configurable options to govern their behavior.

Lastly, if none of the starter kits, plug-ins and widgets are sufficient to address a customer's requirement, the store of the present invention enables the development of new Starter Kits, plug-ins and widgets. Once created, they can be placed into the store for use just by that mobile solution or for use by any other mobile solution, depending on the developer's intentions. If the developers wish to allow other mobile solutions to use the new Starter Kit, plug-in or widget, they can set the commercial terms for such use.

The process of composing an application out of starter kits, plug-ins and widgets is facilitated via Application Studio software, which may include some or all of the following functionality:
Select a Starter Kit and automatically use it to create an application
Remove undesired plug-ins
Select and add plug-ins and widgets
Configure the application using the configuration options which are included in each Starter Kit, plug-in and widget: for example, when the time sheet plug-in is added into an application, configuration options may allow definition of which types of information users must supply before the application allows the users to submit the time sheet
Set business rules and workflows
Define integration with other systems
Fine-tune business object definitions and user interfaces
Preview, test and debug the application's behavior across the different server-based components, and (if relevant) client-device components software, optionally via simulation of the behavior in order to enable testing across a wide range of client devices.
Perform testing of full solution with respect to quality, scalability and communication performance
Proceed to roll-out

Optionally, all this is done via an Integrated Development Environment (IDE) where all these features are accessible.

Optionally, the application is always “alive.” That is, it is available for use while it is being constructed, assembled and configured. This is enabled by the fact that it starts its life by being a copy of a starter kit which is already ready for use. As explained above, this enables the customer to evaluate the application and decide whether the “WISIK point” has been reached; and if not, it is often possible to perform the required changes very quickly using the Application Studio, e.g., change some configuration, define or modify business rules, add plug-ins and widgets, etc.

Making the application “alive” means making it available over the Internet. This is done within the store's application construction area, where the application builder can interact with the latest version of the application. If using the application requires installing some of its components outside the store, as is common in mobile “native” applications where part of the application, at least the user interface, requires installation on the mobile device, e.g. a smartphone or tablet, the construction area includes a quick way of downloading those components. In the mobile application example, the components would be downloaded to the mobile device.

An additional option is to deploy the application (make it “alive”) outside the store's services. In this option, the store includes tools to package and deploy the application to some other set of servers (whether physical or virtual) accessible from the Internet.

Note: Most of the description here assumes that the Application Studio is provided over the internet from one or more central servers. However, it is also possible to implement this invention with an Application Studio that is downloaded to the application creator's computer, and accesses the store to download the various Starter Kits, add-ons and widgets required by the application creator. In that case, the application may be made available for testing in the store's construction area or in some other environment provided by the application developer.

The store is designed to facilitate various types of needs for organizations that need to create and deliver business software applications, including:
Independently creating and configuring applications, using the Application Studio
Interacting with the new application, within the construction area
Contracting consultants advise on the business aspects and/or the technical parts of building the application, involving the consultants in any part of the work up to fully outsourcing the application creation
Contracting specific services required for the application: examples of such needs were given above when discussing the roles involved in business applications
Interacting with the application store's user community
Negotiating and setting financial terms for use of the applications or any other service offered via the store

Regarding the financial terms, the invention supports various types of pricing models. For consulting, payment may be per hour or fixed-cost model. For services, pricing would depend on the nature of the service. Beyond that, each customer may need to pay for some or all of the components involved in the full application:
The infrastructure platform
The business application platform
The starter kit which the application is based on
Plug-ins and widgets used by the application
   Potential pricing models include any mixture of the following:
Payment by number of users
Payment by number of transactions in a specific time period (“per use”)
Payment per the number of applications used (clearly each business may deploy more than one application)
Payment per platform functionality used, for example, it may be cheaper to deploy an application that only uses a subset of the platform's capabilities
Payment per types of supported client devices
Payment per selection of infrastructure platform, as mentioned, the architecture allows a selection of underlying infrastructure
Payment per integration to other systems

Clearly, payments for a single application may need to go to several different entities, out of a list including the store itself, software vendors contributing components to the store, service providers, and consultants. Apart from payments made by customers for creating and deploying the applications, other financial arrangements may also be required and facilitated by the store. For example, software vendors may be required to pay the store's owners and/or store operators for participating in the store and using the development tools.

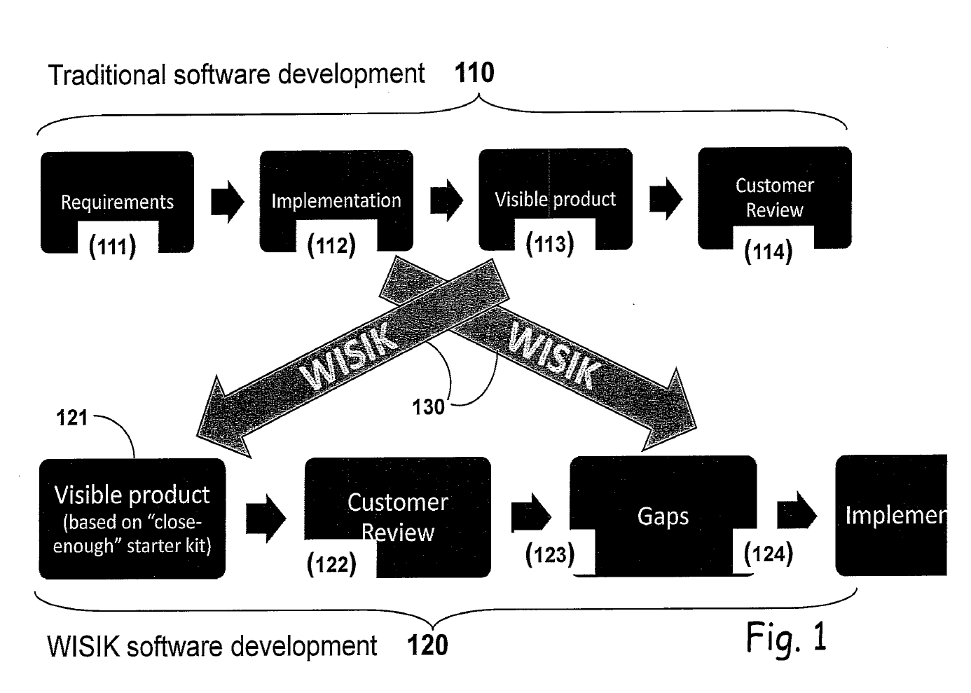

FIG. 1 is a schematic diagram illustrating the WISIK and Starter Kit high-level concepts, constructed in accordance with the principles of the present invention. The top row 110 in the diagram shows a simplified process of traditional software development: first, the software developer interviews the customer to generate requirement documents 111, which are often very large. Next, the software developer works on implementing a solution 112 that answers these requirements. This often takes weeks, months or even years. Only then, when the solution is visible 113 and usable, it becomes possible for the customer to have hands-on experience with the product. At this time, experience shows that the customer will inevitably discover the many places where the requirements weren't fully thought out, or were subject to misunderstandings etc. Now the requirements documents have to be revised 114, the software must be fixed, and the cycle repeats, almost always inducing delays and cost over-runs.

The bottom row 120 of the diagram shows how WISIK inverts the sequence. The inversion is illustrated by the two arrows 130 between the rows. Thus one begins with a visible, testable product 121, based on a “close-enough” Starter Kit as described above. Now the customer can directly and immediately evaluate 122 the solution and identify where it needs to be revised or extended 123. Since the original solution was close enough, most of the expense and time of writing requirements, not to mention revising them after the customer discovers their flaws, is simply avoided. Using quick application construction, with minimal or no writing of software code, the process can be iterated much faster to achieve a satisfactory implementation 124. Note that this is usually impossible with traditional application development process 110, since it typically starts with an empty project rather than a starter kit, and therefore it requires far more software coding.

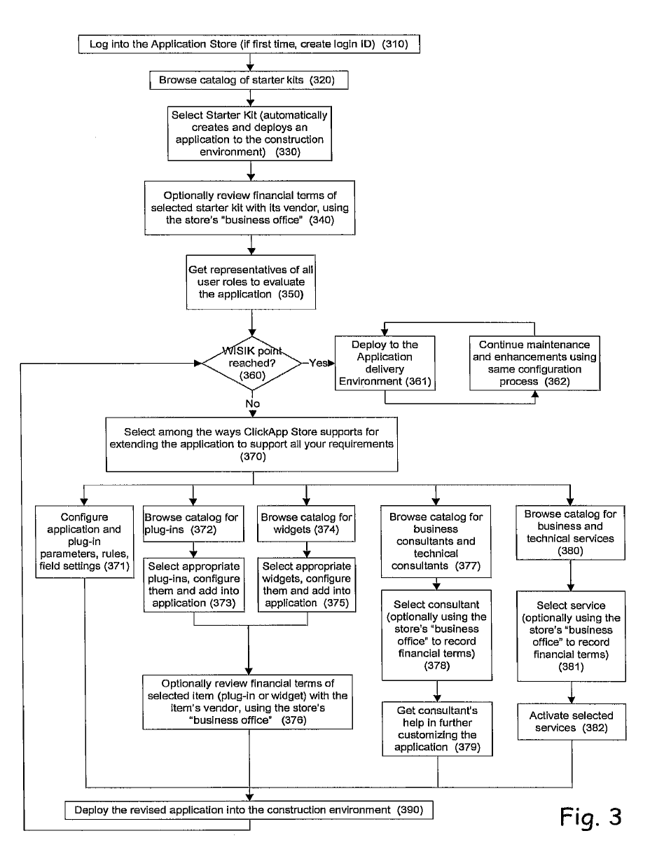

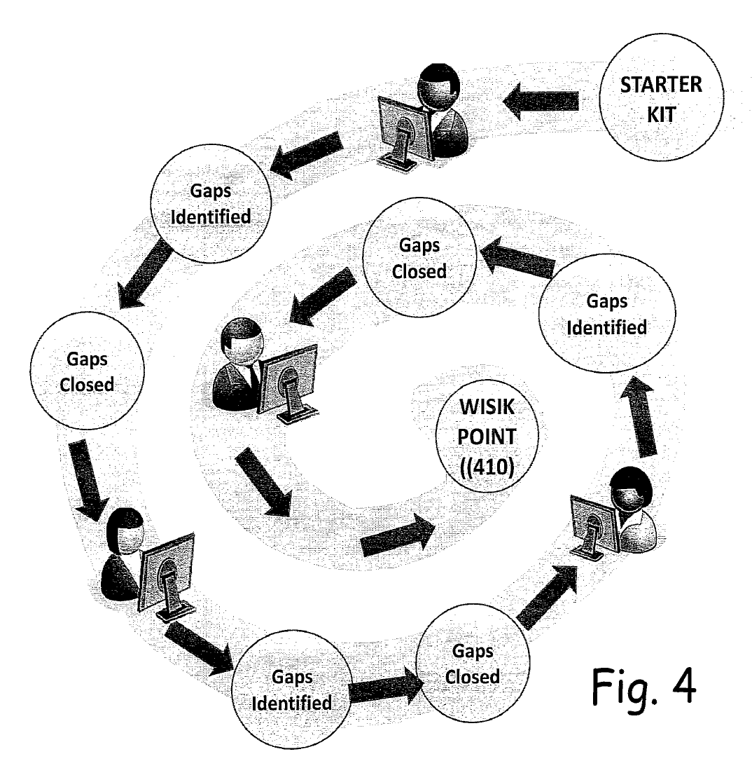

The details of how WISIK is applied in the application store are described with reference to FIG. 3 below. A view of the iterative nature of WISIK is described with reference to FIG. 4 below.

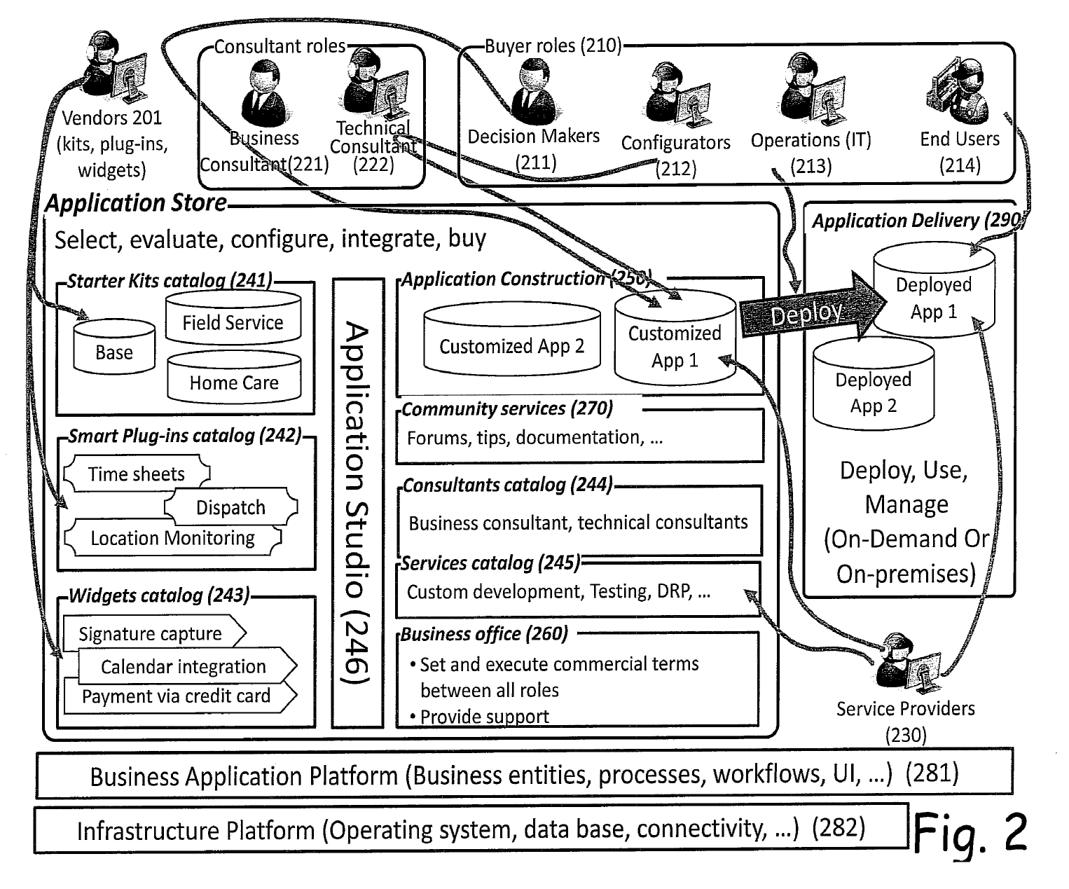

FIG. 2 shows the components of the application store, constructed in accordance with the principles of the present invention.

The application store, named application Store in the diagram, is a set of services, made available over the internet, under models variously known as “Software as a Service” (SaaS), “Cloud,” “Hosted service,” and “On Demand.” These terms may describe somewhat different architecture and business models, and the implementation may choose any of these models.

The main users of the store may have the following roles:
1. Buyer roles 210:
   a. Decision makers 211: typically involving one or more executives responsible for specific business processes and/or for financial decisions and/or for managing the organization's Information Technology (IT) systems. Decision makers 211 may interact directly with the application being constructed, or contract business analysts to do that for them as shown in FIG. 2.
   b. Configurators 212: responsible for configuring and setting up the software solutions to match the organization's needs, and to repeat the configuration process from time to time as the requirements change. Configurators 212 may interact directly with the application being constructed, or contract technical consultants to do that for them as shown in the figure.
   c. Operations 213: responsible for deploying the software solution and assuring its proper behavior, including such tasks as integration with other software systems, granting and managing access privileges, assuring information security, providing the software to each user, e.g. installing “native applications” on mobile devices, and communicating with the support services provided by vendors and consultants
   d. End users 214: the people to which the organization provides the solution in order to assist them with performing relevant activities, whether these are the organization's employees, customers, partners or have any other type of relationship with the organization
2. Provider roles:
a. Software vendors 201: developers of the starter kits, plug-ins and widgets (see explanations below)
   b. Business consultants 221: offering advice and guidance to the customer organization regarding which business processes should be assisted by software, and how to design the automation, decision-making, integration and workflow in order to maximize the organization's business goals
   c. Technical consultants 222: offering services in selecting, assembling and delivering the technological solution to the business requirements (as defined by the customer and/or the business consultant)
   d. Service Providers 230: delivering such services as custom software development, testing and quality assurance, information security assessment, Disaster Recovery Planning (DRP) and more

As mentioned above, the store is optionally built on a business application platform 281, which in turn is built upon an infrastructure platform 282, and may use any number of alternative infrastructure platforms.

The store is composed of the following areas:

Catalogs: The store delivers several kinds of catalogs. Each of these is intended to hold different types of information and software, and to enable browsing through these items, locating documentation about each of them, making financial arrangements regarding the use of each item and more. Catalogs may include mechanisms for community interaction, such as enabling users to read and create comments and ranking for each item in each catalog. The catalogs include:
1. Starter kit catalog 241;
2. Plug-in catalog 242;
3. Widget catalog 243;
4. Consultants catalog 244; and
5. Services catalog 245

Application Studio 246: described above.

Construction area 250: described above, named “Application Construction” in the figure. This is where applications are created, assembled and configured.

Business office 260: described below

Community services 270: this area in the store is provided for all participants, including all role types described above, can share information, post documents, collaborate on projects, discuss challenges and new ideas etc.

This area may adopt internet community mechanisms such as forums, blogs, tagging, shared-space collaborations, virtual meetings, and social-network interaction.

Business office 260: this area is dedicated to the commercial interactions involved in the processes described here. As mentioned above, there may be interactions between buyers and the store itself, e.g., paying for use of the platforms, or the store-managed delivery environment; between the buyer and the vendors of the starter kits, plug-ins and widgets; between the buyer and various types of consultants; and between the buyer and the service providers. There may also be other types of commercial interactions between the roles mentioned here. The use of the business office is optional: Unlike consumer-oriented application stores, where prices are fixed and not subject to negotiation so that the purchasing process is simple and automatic, the business-oriented application store is subject to much more negotiation and detailed contracts. These may or may not be performed within the store, but if they are performed in the store, the “business office” provides the negotiating parties with tools to record the agreement, and optionally to enforce it. As example of enforcement, a starter-kit's vendor may configure it so that the customer won't be able to use it or possibly use it only for a limited period for evaluation until the customer pays for it.

Once the buyer is finished with the store and is ready to run the application, the application needs to be deployed to the delivery environment, named “Application Delivery” 290 in the figure. This environment may be provided over the Internet similarly to how the applications are provided in the construction area, but optionally supporting the higher robustness, security and scalability required for real-life deployment of mission-critical business applications. Alternatively, buyers may create separate environments, possibly on their own premises. In both cases, the store includes a deployment mechanism to install and activate the application so that it is ready for production use. Many buyers will want to perform testing, including scalability and performance, at this point, before starting full production).

FIG. 3 is a flow chart of the process of using the application store, from the point of view of the customer roles (operations, IT, finance), constructed according to the principles of the present invention. Consultant roles are shown (bottom right) in their interaction with customer. Vendors are shown via their contribution into the store's catalog. First a potential buyer logs into the application store. If this is the first time, a login ID is created 310. Next, the buyer browses the catalog of starter kits 320, and selects a starter kit, thereby automatically creating and deploying an application to the construction environment 330. Optionally, he reviews financial terms of selected starter kit with its vendor, using the store's “business office” 340. He then gets representatives of all user roles to evaluate the application 350.

If the review performed by the user representatives determines that the WISIK point has been reached 360, he deploys to the application delivery Environment 361 and may continue maintenance and enhancements using the same configuration process 362 throughout the application's life cycle. If the WISIK point has not been reached 360, he selects among the ways the Application Store supports extending the application to support all of his requirements 370: he configures the application and plug-in parameters, rules and field settings 371; he browses the catalog for plug-ins 372 and selects the appropriate plug-ins, configures them and adds them into the application 373; he browses the catalog for widgets 374 and selects the appropriate widgets, configures them and adds them into the application 375; following reference blocks 373 or 375 he has the has the optional to review the financial terms of the selected item (plug-in or widget) with the item's vendor, using the store's “business office” 376;

Other ways the application store supports extending the application to support all of his requirements 370 include browsing the catalog for business consultants and technical consultants 377, selecting a consultant (optionally using the store's “business office” to record financial terms) 378 and getting the consultant's help in further customizing the application 379 and include browsing the catalog for business and technical services 380, select services (optionally using the store's “business office” to record financial terms) 381 and activating the selected services 382.

Finally he deploys the revised application into the construction environment 390 and returns to determine whether the WISIK point has been reached 360 and continues the cycle from there.

Note the optional inclusion of the “business office” to manage commercial terms of the buyer's selected components: starter kits, plug-ins, widgets, services.

FIG. 4 is another view of the iterative process detailed in FIG. 3, combining it with the concept of WISIK and “WISIK point 410,” by showing a sequence of iterations leading to buyer's decision that the application now meets all the needs, and is constructed in accordance with the principles of the present invention.

In another possible manifestation of the invention, there exist multiple instances of the application store. For example, a large organization could set up its own application store for enhanced security and control, and for internal sharing of components specific to that organization. Thus, the application store enables integrating apps and other enterprise software of that specific organization into coherent solutions with streamlined user experience. Optionally, components (such as Starter kits and plug-ins) may be copied between different application store instances.

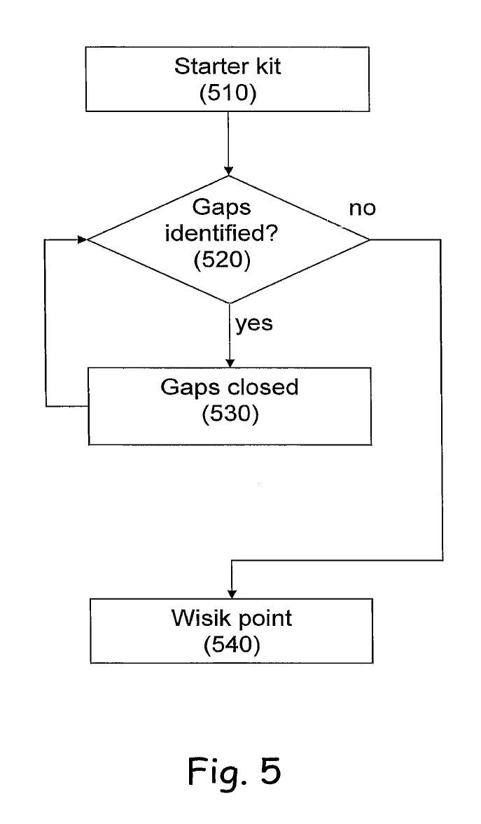

FIG. 5 is flow chart summary of the iterative process in FIG. 4, constructed in accordance with the principles of the present invention. A Starter kit is selected 510. If gaps are identified 520, the gaps are closed 530 via usage of the application studio, and again gaps are checked for 520, such that iterations continue until no gaps are identified 520, such that the WISIK point is reached 540.

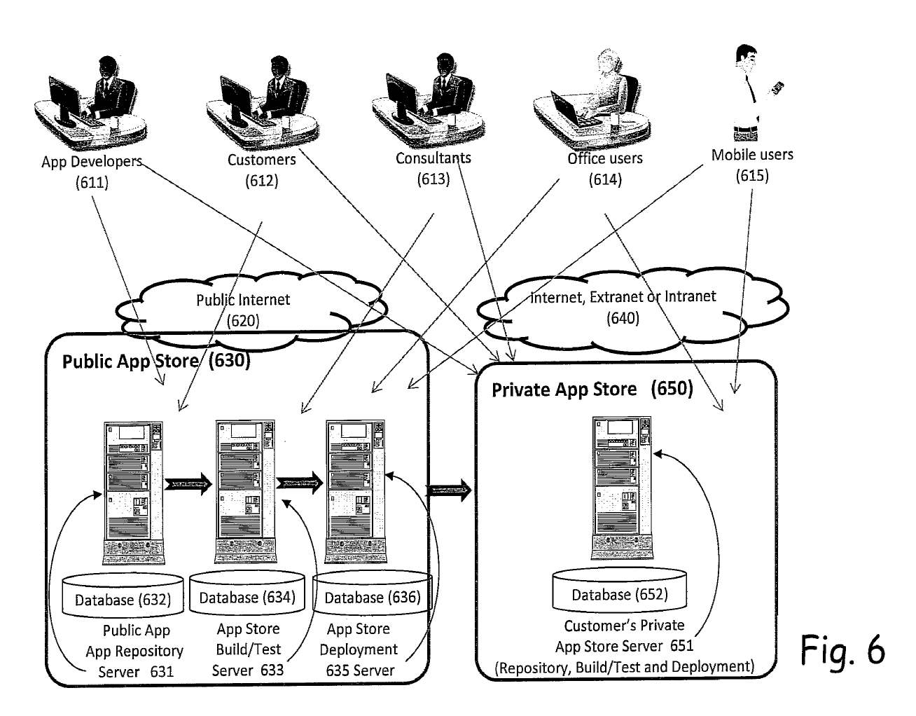

FIG. 6 is system diagram illustrating two preferred embodiments, public and private, constructed in accordance with the principles of the present invention. Users, including application developers 611, customers 612, consultants 613, office users 614 and mobile users 615, can all access both the public application store 630 and the private application store 650, via the public Internet 620 and either the Internet, Extranet or Intranet 640, respectively. Public application store 630 includes an application repository server 631, a build/test server 633 and a deployment server 635, with respective databases 632, 634 and 636. Private application store 650 includes a combined customer's private application store server 651 for repository, build/test and deployment, in conjunction with database 652.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for selling each of a plurality of applications via an application store configured as a centralized virtual shop, said method comprising:
selecting a starter kit by a member of a user organization that attempts to match needs;
enabling a plurality of application buyers and application configurers to work with the starter kit to discover any gaps that may remain;
plugging-in additional applications and widgets and removing unneeded components to assemble a full solution;
configuring and tuning the application; and
setting parameters for and testing the application.

2. The method of claim 1, further comprising deploying the application by installing it into mobile devices of its users' population.

3. The method of claim 1, further comprising developing any application modules which do not exist within the enterprise application store.

4. The method of claim 1, further comprising selling said modules to others via the application store.

5. The method of claim 1, further comprising facilitating finding, selecting, building, assembling, buying and installing business software, as commonly provided in mobile consumer application stores.

6. The method of claim 1, further comprising enabling business applications that provide enterprise IT functionality and other functionality via mobile devices.

7. The method of claim 6, wherein mobile devices enable mobile access to the level enjoyed by business workers within their offices.

8. The method of claim 6, wherein the functionality via mobile devices is mobile access to business functionality related to field activities outside the office.

9. The method of claim 1, further comprising enabling multiple instances of the application store.

10. The method of claim 1, wherein an enterprise organization provides an application store for enhanced security and control.

11. The method of claim 1, wherein an enterprise organization provides an application store for internal sharing of components specific to that organization.

12. The method of claim 11, wherein the application store, by providing for internal sharing of components specific to that organization, enables integrating applications and other enterprise software of that specific organization

13. The method of claim 12, wherein the components comprise at least Starter kits and plug-ins that may be copied between different application store instances.

14. The method of claim 1, further comprising performing a sequence of iterations of the sequence of enabling step through setting step, by at least one of the plurality of buyers leading to the buyer's decision that the application now is ready to be operational.

15. The method of claim 1, further comprising deploying the application.

16. The method of claim 15, wherein deploying the application outside the store's services comprises at least implementing tools to package and deploy the application to some other set of servers accessible from the Internet.

17. The method of claim 1, wherein the business applications are made available over the web or installed on the user's servers and end-user devices for use, evaluation and testing throughout the integration, customization and configuration process.

18. The method of claim 1, wherein software tools used for integration, customization and configuration are used over the web.

19. The method of claim 1, wherein software tools used for integration, customization and configuration are installed on the developer's computer.

20. A system for selling applications requiring non-trivial integration, customization and configuration via an application store configured as a centralized virtual shop, serving at least one of developers, customers, consultants, testers, service providers, information technology (IT) operators, office users and mobile users, said method comprising:
a public application store accessed via the public Internet, comprising:
an application repository server and dedicated database;
a build/test server and dedicated database; and
a deployment server and dedicated database; and
a private application store accessed via either the public Internet, an Extranet or an Intranet, the private application store comprising a combined customer's private application store server or repository, build/test and deployment, in conjunction with a dedicated database.
